(19) United States
(12) Patent Application Publication
(10) Pub. No.: US 2008/0133101 A1
(43) Pub. Date: Jun. 5, 2008

(54) Method and Device for Suppressing a Lateral Rollover Tendency of a Vehicle

(75) Inventors: Jurgen Woywod, Morfelden (DE); Ralph Gronau, Wetter (DE); Artur Kost, Bad Soden (DE); Michael Horn, Steinbach/Ts (DE)

Correspondence Address: RATNERPRESTIA, P O BOX 980, VALLEY FORGE, PA, 19482-0980, US

(73) Assignee: CONTINENTAL TEVES AG & CO.OHG, Frankfurt am Main (DE)

(21) Appl. No.: 11/630,591

(22) PCT Filed: Jun. 24, 2005
(86) PCT No.: PCT/EP05/52965

§ 371 Date: Aug. 28, 2007

(30) Foreign Application Priority Data
Jun. 25, 2004 (DE) 10 2004 030 891.8

(51) Int. Cl. B60T 8/1755

(52) U.S. Cl. 701/83

(57) ABSTRACT

A method for suppressing a lateral rollover tendency of an at least two-axle and at least two-track vehicle, wherein when a first threshold value of a dynamic and/or static quantity correlating with a vehicle lateral acceleration is exceeded, maximum brake pressures are introduced into the wheel brakes of the vehicle as a rollover prevention, with the threshold value representing a value at which a risk of rollover is encountered at a permissible vehicle load of any type; and a second threshold value of a quantity correlating with the vehicle lateral acceleration is provided, at which low brake pressures are introduced, which is lower than the first threshold value, and wherein the quantity correlating with the vehicle lateral acceleration represents a low rollover tendency level.

This application is the U.S. National Phase Application of PCT International Application No. PCT/EP2005/052965, filed on Jun. 24, 2005, which claims priority to German Patent Application No. DE 10 2004 030891.8 filed on Jun. 25, 2004.

### BACKGROUND OF THE INVENTION

1. Technical Field

The present invention relates to a method for suppressing a lateral rollover tendency of an at least two-axle and at least two-track vehicle, wherein when a first threshold value of a dynamic and/or static quantity correlating with a vehicle lateral acceleration is exceeded, maximum brake pressures are introduced into the wheel brakes of the vehicle as a rollover prevention, with the threshold value representing a value at which a risk of rollover is encountered at a permissible vehicle load of any type.

2. Description of the Related Art

In his book “Fundamentals of Vehicle Dynamics”, Society of Automotive Engineers, Inc., Warrendale 1992, Chapter 9, p. 309-333, T. D. Gillespie describes different models for roll-over accidents. The conditions for existing risks of rollover are calculated beginning with a quasi-stationary model for a rigid vehicle via a quasi-stationary model for a suspended vehicle up to dynamic models, taking into consideration the natural roll frequency.

When the book was published, it had already been known that lorries, trucks, busses, minibuses and off-road vehicles in case of cornering with a large roll movement present a tilting risk due to elevated centers of gravity and/or small track widths, but it has shown only recently that passenger cars as well, particularly in case of sinusoidal steering movements, may build up oscillations, which increase to such an extent that the cars tilt. Such a danger of rollover is increased considerably by inappropriately loading the vehicle, i.e. extremely on one side or on the vehicle roof, because the position of the mass center of gravity of the motor vehicle is displaced upwards or to one side.

DE-A 197 46 889 discloses a system for increasing the lateral stability in case of cornering, which is provided with a device for detecting the inclination. Said device either measures the level difference between the right and the left sides of the vehicle or the lateral acceleration of the vehicle in order to detect the roll angle between the vehicle level and the road level. If the device recognizes a risk of rollover, braking the front wheel that is on the outside of the bend causes a correcting yawing moment.

As already described above, however, the admissible lateral acceleration as well as the admissible roll angle depend on the position, in particular the level of the center of gravity of the vehicle.

Therefore, methods of increasing the lateral rollover stability of a vehicle have been disclosed, wherein at the beginning of driving a value is assumed as a stability threshold for the lateral acceleration, which value ensures that with any—legally allowable—loading, rollover can be prevented with greatest likelihood by a control intervention, if this is physically possible. In the further course of driving, monitoring of the wheel sensor signals allows making further conclusions as to the location of the mass center of gravity, which conclusions possibly permit raising this threshold.

Hence, at the start of driving, it is not the center of gravity of the empty vehicle, but the possibly most unfavorable center of gravity of the vehicle in consideration of the admissible vehicle load that is taken into account for calculating a stability threshold, which must be exceeded in order to initiate a brake intervention. However, it ensues from the design that the predominant number of vehicles exhibiting a ‘normal’ load condition (frequency >>90%) are limited in terms of driving dynamics and that ‘faulty interventions (faulty control activations)’ may occur. Especially in view of this aspect, previous ARP (Active Rollover Protection) systems have performed the ARP intervention at a latest possible time, depending on the system dynamics of the brake system. In turn, the consequence of this fact is the necessity of utilizing the maximum system dynamics of the brake system and, hence, performing very ‘intense’ brake interventions, which in this case generally generate the brake pressure by way of the pump and the brake booster. Special solutions have also been applied in this respect in order to build up brake pressure in the wheel brake cylinders as quickly as possible. If a faulty intervention occurs nevertheless, in spite of the intervention threshold which is set high and fully utilizes the system dynamics of the brake system, this fact becomes especially conspicuous and disturbing due to the intensity of the brake intervention.

### SUMMARY OF THE INVENTION

It is, thus, the object of the invention to provide a method and a device, which appropriately counteract a risk of rollover in consideration of even an unfavorable load, and diminish any inconvenience caused to the driver in case brake interventions take place unnecessarily.

This object may achieved using a generic method in that a second threshold value of a quantity correlating with the vehicle lateral acceleration or a lateral acceleration quantity is provided, upon the exceeding of which low brake pressures are introduced, and the second threshold value is lower than the first threshold value, and wherein the quantity correlating with the vehicle lateral acceleration or the lateral acceleration represents a low rollover tendency level.

This object may also achieved by a generic device in that the device actuates the brake apparatus in such a manner that the vehicle is decelerated by the braking operation without any noticeable yaw torque change when the rollover tendency quantity exceeds a second threshold value that is representative of a relatively low rollover tendency level, and the device actuates the brake apparatus in such a way that a yaw torque counteracting an rollover tendency is applied to the vehicle when the rollover tendency quantity exceeds a defined first threshold value, which is higher than the second threshold value and represents a relatively high rollover tendency level.

Advantageously, a Pre_ARP mode is achieved, which renders ARP interventions ‘softer’ and, thus, less noticeable, without impairing the rollover safety under extreme load conditions of the vehicle. The driver will not sense any essential consequences of the intervention as the wheels are braked individually and/or the engine torque is reduced in order to decelerate the vehicle in a range, in which no noticeable yaw torque is generated by braking and/or the engine intervention, when a rollover tendency of the vehicle at a defined threshold is assumed and the threshold for executing such pre-braking is exceeded in a relative stage of the increase of the rollover tendency. As the rollover tendency is influenced by the vehicle speed, it is possible that in some driving situations the rollover tendency is eliminated already by such pre-braking, which is initiated at a relatively low rollover tendency level so that no noticeable change of the yaw torque is brought about by individual braking. If, however, the rollover tendency level finally reaches or exceeds the first threshold value, a torque counteracting the rollover tendency will reduce the lateral forces of at least one vehicle wheel in a controlled manner. This intervention, however, may then be carried out in a less ‘hard’ fashion due to the Pre-ARP control. The action limits the lateral force that can be transmitted by the tire, and the roll angle of the vehicle is maintained in the uncritical range. By means of vehicle-related modeling, using a table of stored parameters in the simplest case, the approach of an imminent rollover condition is detected, and active braking is performed on at least the front-axle wheel that is on the outside of a turn, namely to such an extent that considerable understeering is achieved (but less strong than without Pre_ARP).

### BRIEF DESCRIPTION OF THE DRAWINGS

FIG. 1 is a schematic representation of an exemplary course of a fish-hook maneuver.

### DESCRIPTION OF THE PREFERRED EMBODIMENTS

The ARP system considers two possible driving conditions in which a vehicle turns over: static driving maneuvers and maneuvers with high vehicle dynamics. During the static maneuver, the vehicle rides in curves with a constant radius and at rising vehicle speed or with a receding radius and at constant speed (with possibly high friction of the roadway). The effect is the same, i.e. rising lateral acceleration. Only few vehicles with an unfavorable ratio of track width and height of center of gravity tend to turn over slowly. The ARP system reduces the risk of rollover by reducing the torque of the engine (so that no further vehicle acceleration is possible) and/or by the brakes intervening (in order to reduce the vehicle speed), whereby the lateral acceleration of the vehicle is limited.

The other reasons for rollover of a vehicle are maneuvers with high dynamics. Typical maneuvers are the ‘fishhook’ and double lane change. These maneuvers are characterized by high steering dynamics (with possibly high friction of the roadway). A number of vehicles tend to rollover, depending on the track width and the height of the center of gravity as well as the damping.

The dynamic ARP system prevents the rollover of a vehicle during maneuvers with high dynamics, as is disclosed in EP 133 40 17 A1.

It is, therefore, arranged in a favorable way that the correlating quantity is the lateral acceleration itself, the steering angle velocity, the steering wheel angle velocity, the yaw rate, and/or the deviation of the vehicle, which is produced from the measured yaw rate and the nominal yaw rate calculated in a vehicle model, and/or derivatives of the quantity. The correlating quantity, which is considered for the rollover prevention measures, can consist of one or more of these signals, and particularly an evaluation of the lateral acceleration and the steering angle or steering wheel angle velocity is provided with respect to the static and dynamic conditions of the vehicle. The contents of EP 133 40 17 A1 describing a dynamic driving maneuver and the contents of EP 140 45 53 A1 describing a quasi-stationary driving maneuver are a component part of the method at issue and the device according to the invention.

It is suitable that the correlating quantity is a function of the vehicle lateral acceleration and its time derivative.

It is favorable that the vehicle is decelerated by braking without noticeable change in the rollover tendency when the second, lower threshold value is exceeded, while a yaw torque counteracting the rollover tendency is applied to the vehicle when the first threshold value is exceeded, the said counteracting torque being put into practice at least by way of introducing brake pressure into the wheel brake of the outside wheel in a turn. As an applied yaw torque also causes a slight, scarcely perceptible understeering tendency of the vehicle, this understeering tendency can already be triggered by such pre-braking, which is triggered at a relatively low level of the rollover tendency, which level is checked by means of the second threshold value.

Advantageously, this slight understeering tendency can be produced in a comfortable manner by way of braking the curve-outside front wheel and the curve-outside rear wheel.

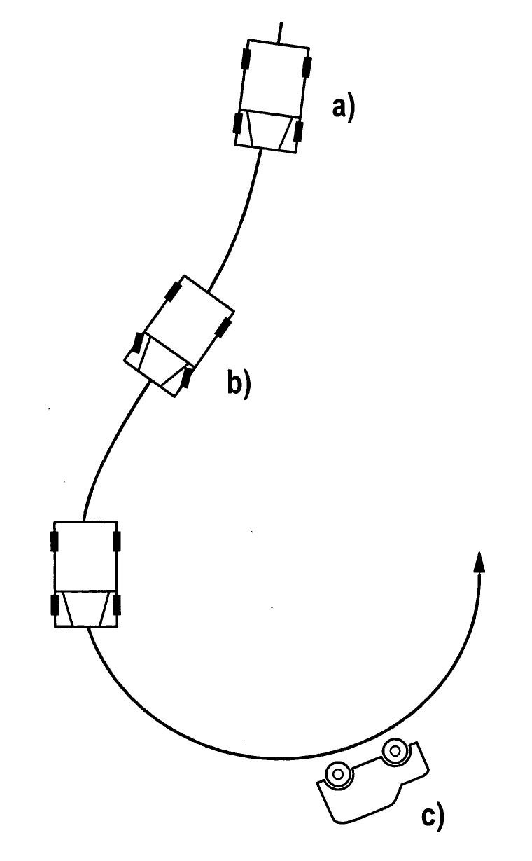

It is favorable that in driving-dynamics situations in which the vehicle is steered from a left-hand curve into a right-hand curve or from a right-hand curve into a left-hand curve (alternating-dynamics maneuver), brake pressure is introduced also into the inside wheel in a curve when the second threshold is exceeded. An alternating-dynamics maneuver is the so-called ‘fishhook’ movement with a strong roll moment effect. This maneuver demands from the driver to steer an angle of 270 degrees as fast as possible and, subsequently, steer 870 degrees as fast as possible in the opposite direction. FIG. 1 shows the course of a typical fishhook maneuver. The vehicle is riding in a wide curve at high speed and high lateral acceleration (8-9 m/ss), see position a). In this driving situation, the driver performs a quick and dangerous countersteering maneuver causing rollover of the vehicle.

In a maneuver of this type, the ‘two-stage’ ARP intervention, during which the first threshold value is reached or exceeded only in the ‘hook’ of a fishhook maneuver (slow driving into a bend -->quick countersteering), leads to advantages due to the pre-intervention when the second threshold is exceeded. The advantages involve the faster pressure buildup in the countersteering situation, reduction of the roll movement, reduction of the subsequent intervention intensity of braking when the first threshold is exceeded, and the reduction of the vehicle speed. For this purpose, the controller includes an alternating-maneuver detection, e.g. corresponding to the embodiments in EP 133 40 17 A1, by which an early intervention, possibly even on two wheels, takes place with lowered ARP entry thresholds. There are insignificant effects on steering the vehicle owing to the alternating-maneuver detection.

The first threshold value can be exceeded favorably by introduction of the lower brake pressure at the second threshold value, in order to reliably prevent rollover at admissible vehicle load of any type.

The Pre_ARP mode is started depending on the signals that are taken into account for the ARP activation. However, the second threshold for the activation of the Pre_ARP mode is remarkably below the first threshold for the ARP entry. The second threshold value is either an invariably predefined value or a value determined for the respective driving condition of the vehicle. The latter value can be determined beforehand by driving tests and with the aid of simulations or by means of a performance graph. Or the second threshold value is found out during operation of the vehicle at least depending on the lateral acceleration, the steering angle velocity or the steering wheel angle velocity, the yaw rate, and/or the deviation produced from the measured yaw rate and the nominal yaw rate calculated in a vehicle model. When this second threshold is reached, the prior art separating valves of the brake system (EP 0807039 B1=P 7833) are closed and an active pressure buildup is initiated, as is known from the ESP intervention (U.S. Pat. No. 5,671,143).

The dimensioning as well as the allocation of the intervention wheel of the built-up pressure to be introduced is carried out by means of the algorithm e.g. known from DE 101 30 663 (P 10149).

An adaptation to the vehicle-related values (mass, track width, brake system, etc.) can be performed using a vehicle-responsive weighting factor, which ranges between 0.2 and 0.8. Limitation of the absolute brake pressure, which can be monitored in a model-based or sensor-based fashion, is provided in order to limit the magnitude of the brake pressure that is to be introduced into at least one wheel when the second threshold is reached or exceeded. Preferably, the brake pressure to be introduced is <25% of the locking pressure level. The pressure level introduced by means of this method will slightly reduce the dynamics of the vehicles (as tests using the algorithm of P 10149 have shown), but take major influence on the rollover tendency. Another positive effect of the Pre_ARP mode is the reduction of the bonanza effect of the vehicle (rollback), which should not be ignored, what has especially adverse effects in the initial range of a pressure buildup desired with high dynamics. The dynamics of the vehicle, which is slightly reduced due to the Pre_ARP mode (due to the vehicle deceleration), and the volume absorption of the brake system (of the wheel ‘concerned’) that is already in the linear range allow introducing the actual (hard) ARP intervention, with maximum system dynamics, at a higher first threshold value. The result is greater fail-safety as regards spurious control.

1-12. (canceled)

13. A method of suppressing a lateral rollover tendency of an at least two-axle and at least two-track vehicle comprising the steps of:
defining a first threshold value of a dynamic, static, or combined dynamic and static quantity correlating to a lateral acceleration quantity; the first threshold value representing a quantity at which a risk of rollover occurs at any permissible vehicle load;
defining a second threshold value of a dynamic, static, or combined dynamic and static quantity correlating to the lateral acceleration quantity, the second threshold value representing a quantity at which a risk of rollover is low;
comparing a lateral acceleration of said vehicle to said first and second threshold values;
applying maximum brake pressure to wheel brakes of said vehicle when the lateral acceleration exceeds the first threshold value; and
applying low brake pressure to the wheel brakes of said vehicle when the lateral acceleration exceeds the second threshold value but is lower than the first threshold value.

14. The method as claimed in claim 13 wherein the lateral acceleration quantity correlates to a vehicle lateral acceleration, a steering angle velocity, a yaw rate, a deviation of the vehicle, or a combination thereof, which is a function of a measured yaw rate and a nominal yaw rate calculated in a vehicle model.

15. The method as claimed in claim 13 wherein the lateral acceleration quantity is a function of the vehicle lateral acceleration and its time derivative.

16. The method as claimed in claim 13 wherein a yaw torque counteracting a rollover tendency is applied to the vehicle when the lateral acceleration exceeds the first threshold value, said counteracting yaw torque being applied to the vehicle by introducing brake pressure to an outside wheel brake in a turn.

17. The method as claimed in claim 16 wherein brake pressure is also introduced to the wheel brake of the outside wheel in a turn when the lateral acceleration exceeds the second threshold value.

18. The method as claimed in claim 13 wherein, during an alternating dynamics maneuver, brake pressure is introduced to an inside wheel in a curve.

19. The method as claimed in claim 13 wherein brake pressure is introduced to the brake of a rear wheel of the vehicle that is the outside wheel in a curve.

20. The method as claimed in claim 13 wherein brake pressure ranging between 8 and 30 bar is introduced when the lateral acceleration exceeds the second threshold value.

21. The method as claimed in claim 13 wherein the brake pressure that is applied when the second threshold value is exceeded is limited to a value approximately 25% or less than the maximum brake pressure.

22. The method as claimed in claim 13 wherein the brake pressure is weighted with a vehicle-dependent factor between 0.2 and 0.8.

23. A device for suppressing a lateral rollover tendency of an at least two-axle and at least two-track vehicle comprising:
an apparatus configured to determine a dynamic, static, or combined static and dynamic quantity correlating to a lateral acceleration quantity that is representative of a vehicle rollover tendency;
a brake apparatus for braking each of a plurality of vehicle wheels individually;
wherein the brake apparatus is actuated to decelerate the vehicle without noticeable change in yaw torque, when the quantity representative of a vehicle rollover tendency exceeds a second threshold value representative of a relatively low rollover tendency; and
wherein the brake apparatus is actuated to apply a yaw torque counteracting the rollover tendency of the vehicle when the rollover tendency quantity exceeds a defined first threshold value which is higher than the second threshold value and represents a relatively high rollover tendency.

24. A device as claimed in claim 23 wherein the determining apparatus further comprises a lateral acceleration sensor, a steering angle sensor, a yaw rate sensor, and a vehicle model for defining a nominal yaw rate.
